(19) United States
(12) Patent Application Publication
(10) Pub. No.: US 2026/0099867 A1
(43) Pub. Date: Apr. 9, 2026

(54) INFORMATION PROCESSING APPARATUS, PRINTING SYSTEM, AND PRINTING METHOD

(71) Applicant: SEIKO EPSON CORPORATION, Tokyo (JP)

(72) Inventor: Masahiko MIZUTA, Matsumoto (JP)

(21) Appl. No.: 19/350,094

(22) Filed: Oct. 6, 2025

(30) Foreign Application Priority Data
Oct. 8, 2024 (JP) 2024-176258

(51) Int. Cl. G06Q 30/04; G06K 15/00

(52) U.S. Cl. CPC G06Q 30/04; G06K 15/4095

(57) ABSTRACT

An information processing apparatus includes an authentication section configured to perform user authentication, a charging section configured to perform preparation processing for charging a usage fee to an authenticated user for a printing service that causes a printing apparatus associated with the user to print print data via the information processing apparatus, and a printing control section configured to cause the printing apparatus associated with the user to execute printing in response to receiving a print request for the printing apparatus when the preparation processing has been performed, in which the charging section varies a charging mode for the user according to an amount of printing of the printing apparatus.

The present application is based on, and claims priority from JP Application Serial Number 2024-176258, filed October 8, 2024, the disclosure of which is hereby incorporated by reference herein in its entirety.

### BACKGROUND

### Technical Field

The present disclosure relates to an information processing apparatus, a printing system, and a printing method.

### Related Art

In the related art, for example, as described in JP-A-2012-133489, a cloud printing service in which a printer is caused to execute printing via a cloud server from client terminals is known.

In order to provide a cloud printing service, various costs for setting up and maintaining a server are required. For example, there are costs such as a management cost of user information and printer information, and a cost that increases when an amount of printing increases. On the other hand, a mode in which a printer is caused to execute printing by using a cloud printing service varies depending on a user. the amount of printing for causing the printer to execute printing by using the cloud printing service varies depending on the user. There has been a demand for a method for charging usage fees for the cloud printing service to various users according to such usage modes.

### SUMMARY

An information processing apparatus for solving the above problem includes an authentication section configured to perform user authentication, a charging section configured to perform preparation processing for charging a usage fee to an authenticated user for a printing service that causes a printing apparatus associated with the user to print print data via the information processing apparatus, and a printing control section configured to cause the printing apparatus associated with the user to execute printing in response to receiving a print request for the printing apparatus when the preparation processing has been performed, in which the charging section varies a charging mode for the user according to an amount of printing of the printing apparatus.

A printing system for solving the above problem includes an information processing apparatus and a printing apparatus. The information processing apparatus includes an authentication section configured to perform user authentication, a charging section configured to perform preparation processing for charging a usage fee to an authenticated user for a printing service that causes a printing apparatus associated with the user to print print data via the information processing apparatus, and a printing control section configured to cause the printing apparatus associated with the user to execute printing in response to receiving a print request for the printing apparatus when the preparation processing has been performed, in which the charging section varies a charging mode for the user according to an amount of printing of the printing apparatus. The printing apparatus executes printing requested by the information processing apparatus.

A printing method for solving the above problem includes performing user authentication, performing preparation processing for charging a usage fee to an authenticated user for a printing service that causes a printing apparatus associated with the user to print print data via the information processing apparatus, causing the printing apparatus associated with the user to execute printing in response to receiving a print request for the printing apparatus when the preparation processing has been performed, and varying a charging mode for the user according to an amount of printing of the printing apparatus.

### BRIEF DESCRIPTION OF THE DRAWINGS

FIG. 1 is a block diagram showing a configuration of a printing system.

FIG. 2 is a diagram showing an example of a usage mode of a cloud printing service.

FIG. 3 is a diagram showing an example of printer information stored in an information processing apparatus.

FIG. 4 is a sequence diagram showing an example of an authorization sequence.

FIG. 5 is a diagram showing an example of screen transition in a terminal.

### DESCRIPTION OF EMBODIMENTS

Here, embodiments of the present disclosure will be described in the following order.

### 1. Configuration of Printing System:

### 1-1. Configuration of Printer:

### 1-2. Configuration of Server:

### 2. Authorization Sequence:

### 3. Other Embodiments:

### 1. Configuration of Printing System:

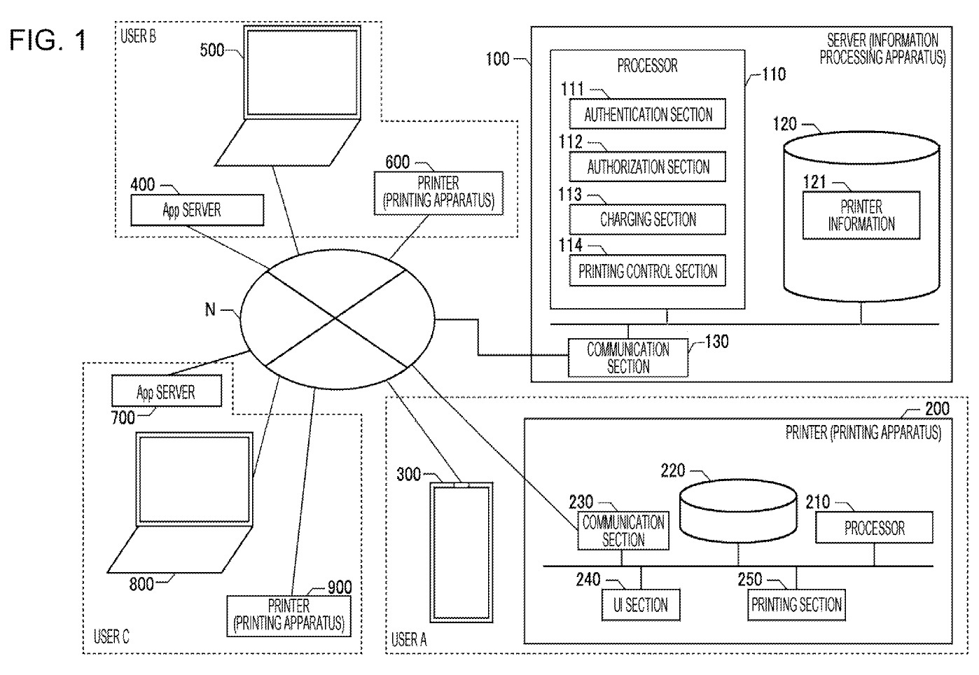

FIG. 1 is a block diagram showing an overall configuration including a printing system according to an embodiment of the present disclosure. The printing system includes a server 100 as an information processing apparatus and at least one of printers 200, 600, and 900 as a printing apparatus. The server 100 provides a printing service for causing a designated printer to print print data via the server 100, that is, a cloud printing service. The server 100 can communicate with the printers 200, 600, and 900 available for the cloud printing service via a network N such as the Internet.

In the present embodiment, a terminal 300 is a terminal operated by a user A who owns the printer 200. The terminal 300 is a smartphone, a PC, a tablet, or the like. The terminal 300 includes a communication section for communicating with other devices, a UI section that displays various kinds of information to a user and receives various kinds of operations of the user, a non-volatile memory that stores various kinds of programs and data, a processor, and the like.

The terminal 300 can communicate with the server 100, App servers 400 and 700, and the like via the network N. The user A uses the terminal 300 when performing user registration of the cloud printing service, registration of a printer used in the cloud printing service, or the like. The user A may own a plurality of printers available in the cloud printing service. One of them is shown in FIG. 1.

The App servers 400 and 700 are servers that provide various services using the cloud printing service. As the various services using the cloud printing service, for example, a printed product sales service, a content distribution service, and the like may be assumed. The printed product sales service using the cloud printing service is a service in which, for example, a photograph such as a class photograph or an event photograph of a school is published on an App server for members, and a desired number of photographs desired by the member are printed by a printer of the company. The content distribution service using the cloud printing service is a service for causing the printer 200 owned by the user A to print various contents from the App server. More specifically, for example, a service may be assumed in which a company that creates newspaper page data causes a printer owned by a newspaper reader to print the newspaper page data. Alternatively, a service may be assumed in which a cram school or a company that creates educational content causes a printer owned by a student to print assignment data for the student.

In the present embodiment, the description will be continued on the assumption that the App server 400 is operated by a user B and the App server 700 is operated by a user C. The users B and C can also be referred to as partners who use the cloud printing service provided by the server 100. The partner indicates, for example, a person or a company. The user A is a general user who uses the content distribution service of the App server 400, the content distribution service of the App server 700, or the like. In the following description, the description will be continued on the assumption that the content distribution service provided by the App server 400 and the content distribution service provided by the App server 700 are services for distributing different contents.

In order to use a content distribution service using such a cloud printing service, the user A performs user registration of the cloud printing service in advance in the server 100. In the user registration of the cloud printing service, the user A registers identification information of the user, a password, and identification information of a printer owned by the user. Here, the identification information of the user is, for example, an email address. When user registration is required for the content distribution service, the user A also performs user registration with the App servers 400 and 700 in advance.

A terminal 500 is a terminal under the management of the user B who operates the App server 400. The terminal is, for example, a smartphone, a PC, a tablet, or the like. The printer 600 is a printing apparatus under the management of the user B who operates the App server 400. Although only one printer is shown in FIG. 1, a plurality of printers may exist under the management of the user B. In the present embodiment, the printer 600 may be assumed to be used as an output destination printer for test printing to test the content distribution service by the App server 400, to be used for causing the printer 600 installed at each base of the user B to print various documents, and the like. Alternatively, the printer 600 may also be assumed to be used as an output destination printer for the printed product sales service by the App server 400.

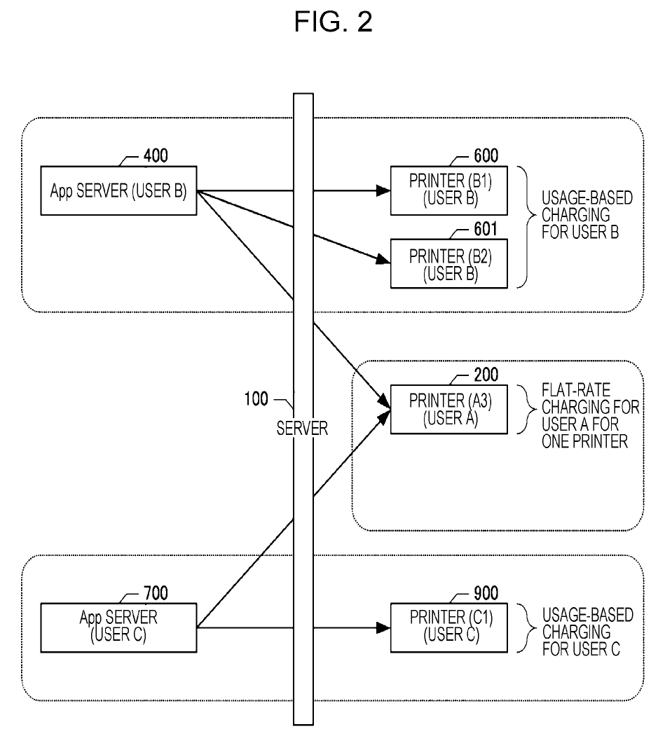

That is, the App server 400 makes a print request to a printer using a WebAPI provided by the server 100, but in the present embodiment, as shown in FIG. 2, the printer of the output destination may be the printer 200 or the like owned by another person (user A) with respect to the user B, or may be the printer 600 or the like owned by the user (user B). In this way, the user B performs user registration for a WebAPI user in advance using the terminal 500 so that the App server 400 can make a print request to various printers using the WebAPI. Hereinafter, the user registration performed by the user B is referred to as partner registration. In the partner registration, an email address and a password as identification information of the user, identification information of a printer owned by the user, and payment information are registered in the server 100. The registration of the payment information is included in preparation processing for charging, which will be described later. The payment information is information for performing payment using a payment method selected by the user, and is, for example, a credit card number, a cardholder name, an expiration date, a security code, or the like when a credit card is selected.

A terminal 800 is a terminal under management of a user C who operates the App server 700. The terminal is, for example, a smartphone, a PC, a tablet, or the like. The printer 900 is a printing apparatus under the management of the user C who operates the App server 700. The printer 900 is used for test printing of the content distribution service by the App server 700, printing of various documents for its own company, a printed product sales service, and the like. Similarly to the user B, the user C also performs user registration for a WebAPI user in advance using the terminal 800. Hereinafter, the user registration performed by the user C is referred to as partner registration. In the present embodiment, the output destination printer of the print request via the WebAPI by the App server 700 may also, as shown in FIG. 2, be the printer 200 or the like owned by another person (user A) with respect to user C, or may be the printer 900 or the like owned by the user (user C).

### 1-1. Configuration of Printer:

In the present embodiment, the printer 200 is a printing apparatus that performs printing on a print medium in response to a print request from the server 100. The printers 600 and 900 also have the same configuration as the printer 200. The printer 200 includes a processor 210, a storage medium 220, a communication section 230, a UI section 240, and a printing section 250. The printer 200 includes a RAM and a ROM (not shown). The processor 210 controls the printer 200 by executing various programs stored in the ROM, the storage medium 220, and the like. The processor 210 may be configured by a single chip or may be configured by a plurality of chips. In the present embodiment, the processor 210 is a CPU, but may be configured by an ASIC or the like, or may be configured by a CPU and an ASIC. When each device according to the present embodiment includes a processor, the processor can be realized in various forms, similarly to the processor 210.

The storage medium 220 stores various programs, such as a control program for controlling execution of printing, and print data transmitted from the server 100. The communication section 230 includes a circuit used for communication with other devices in accordance with various wired or wireless communication protocols. The UI section 240 includes a touch panel display, keys, and the like for displaying various kinds of information to a user and inputting a user operation.

The printing section 250 includes an actuator, a driving component, a mechanical component, a sensor, and the like for executing printing by ejecting ink onto a print medium. The processor 210 executes printing by controlling the printing section 250 based on the print data.

### 1-2. Configuration of Server:

The server 100 includes a processor 110, a storage medium 120, and a communication section 130. The processor 110 includes a CPU, a RAM, a ROM, and the like, and can execute various programs stored in the storage medium 120. The programs that can be executed by the processor 110 include a cloud printing control program for realizing a cloud printing service.

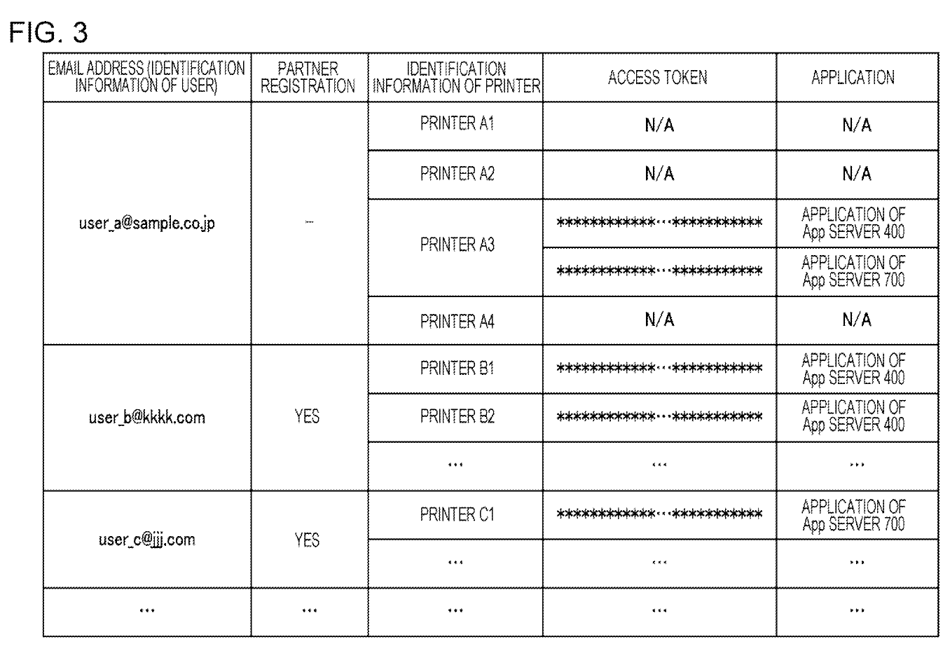

The storage medium 120 stores the cloud printing control program (not shown) and printer information 121. In the printer information 121, as shown in FIG. 3, the email address as the identification information of the user is associated with the identification information of the printer owned by the user. In addition, when an access token, which will be described later, has been issued for the printer, the access token and the application to which the access token has been issued are stored in association with the identification information of the printer. In addition, information indicating whether or not the user is registered as a partner, that is, registered as a user for using the WebAPI, is stored in association with the email address as the identification information of the user.

The communication section 130 includes a communication interface for communicating with other devices based on various communication protocols. The server 100 can communicate with each of the App servers 400 and 700, the terminals 300, 500, and 800, and the printers 200, 600, and 900 via the network N by the communication section 130. The server 100 can communicate with devices such as a keyboard, a mouse, and a display via the communication section 130.

The cloud printing control program realizes a function of varying a charging mode for a user who is an owner of each printer according to an amount of printing of the respective printer when providing the cloud printing service. By executing the cloud printing control program, the processor 110 functions as an authentication section 111, an authorization section 112, a charging section 113, and a printing control section 114. The processor 110 performs user authentication using the function of the authentication section 111. That is, the processor 110 performs authentication processing of determining whether or not a user who attempts to register a printer to be used in the cloud printing service is a valid user who has completed user registration. In the present embodiment, the email address and password of the user are managed by an ID provider (not shown). Therefore, the server 100 requests the ID provider to perform user authentication processing. In the present embodiment, the server 100 cooperates with the App server 400, the ID provider (not shown), and a charging platform (not shown) to be described later. The device that transmits and receives various data to and from the terminal 300 operated by the user switches among the App server 400, the server 100, the ID provider, and the charging platform according to the content of the processing. Here, the various data is, for example, display data of a screen or data indicating input contents or operation contents of the user.

The server 100 charges the user who owns the printer for the usage fee of the cloud printing service. Specifically, by the function of the charging section 113, the processor 110 performs preparation processing for charging the usage fee to an authenticated user. The charging preparation processing refers to processing of setting a state in which the usage fee can be charged to the user at a predetermined time, and includes description of the usage fee, acquisition of payment information for payment from the user, authentication related to the payment information, and the like. In the present embodiment, the server 100 requests the charging platform (not shown) to perform the charging preparation processing. In the present embodiment, the charging platform is a server that performs the charging preparation processing and charging processing based on the payment information at a predetermined time after the preparation processing.

In the present embodiment, the processor 110 varies a charging mode for the user according to the amount of printing by the printing apparatus. Specifically, the processor 110 performs usage-based charging when it is assumed that the amount of printing is equal to or greater than the reference, and performs flat-rate charging when it is assumed that the amount of printing is less than the reference. In order to provide a cloud printing service, various costs for setting up and maintaining the server 100 are required. For example, there are costs such as a management cost of user information and printer information, and a cost that increases when an amount of printing increases. The former cost includes, for example, a cost for maintaining a storage for storing various kinds of information for each user or each printer. The latter cost includes, for example, a cost for maintaining a storage for storing print data for a predetermined period when a print request is received.

When the amount of printing is large for many printers, there is a possibility that profitability can still be achieved even if a fee per unit amount of printing, that is, the unit price is lowered and the usage-based charging is performed for all the printers. However, when there are a large number of printers with a small amount of printing, there is a possibility that profitability cannot be achieved when usage-based charging with a low unit price is performed for all of the printers. Although increasing the unit price increases the possibility of achieving profitability, it may prevent the promotion of the use of the cloud printing service. For this reason, it is conceivable to charge a fee per printer that can cover the management cost. On the other hand, although the management cost of a printer with a large amount of printing is the same as that of the printer with a small amount of printing, a per-printer charge set at the level of the management cost is insufficient to cover the costs required in accordance with the amount of printing. Therefore, by applying usage-based charging when it is assumed that the amount of printing is equal to or greater than the reference, and flat-rate charging when it is assumed that the amount of printing is less than the reference, it is possible to prevent the inhibition of the promotion of the use of the cloud printing service and to increase the possibility of achieving profitability.

In the present embodiment, the flat-rate charging performed when it is assumed that the amount of printing is less than the reference indicates that a fixed amount is charged per printer authorized to perform printing in the printing service. That is, in the present embodiment, when a plurality of printers, each of which is assumed to have an amount of printing less than the reference, are authorized, that is, registered as printers for use in the cloud printing service, an amount obtained by multiplying the charge per printer by the number of registered printers is charged. In this way, it is possible to increase the possibility of achieving profitability even for a printer with a small amount of printing.

In the present embodiment, when it is assumed that the amount of printing is equal to or greater than the reference, an apparatus associated with a user who owns a printer authorized to perform printing in a cloud printing service makes a print request for causing the printer to print print data, and the user acquires a printed matter based on the print request from the printer. That is, this corresponds to a case where an App server that makes a print request using a WebAPI and a printer that performs printing in response to the print request are under the management of the same user (referred to as Case 1). For example, as shown in FIG. 2, a mode in which printers 600 and 601 under the management of the user B is caused to print print data from the App server 400 under the management of the user B via the server 100 corresponds to Case 1. In this case, usage-based charging is performed in accordance with the total amount of printing for a predetermined period in the printers 600 and 601 of the user B. In addition, a mode in which the printer 900 under the management of the user C is caused to print the print data from the App server 700 under the management of the user C via the server 100 also corresponds to Case 1, and the usage-based charging is performed for the user C according to the amount of printing of the printer 900 in a predetermined period. When printing is performed based on the print request using the WebAPI, it is assumed that the print request mechanism is automated on the requesting side, and the motivation for automation is assumed to be a large amount or high frequency of printing, such as for business purposes. As in Case 1, when the output destination printer of the print request is a printer under the management of the side that has made the print request, it is statistically known that the amount of printing is often equal to or greater than the reference, and thus the usage-based charging is adopted in Case 1.

In the present embodiment, when it is assumed that the amount of printing is less than the reference, an apparatus associated with another user different from the user makes a print request for causing the printer authorized to perform printing in the printing service to print print data, and the user acquires a printed matter based on the print request from the printer. That is, this corresponds to a case where an App server that makes a print request using a WebAPI and a printer that performs printing in response to the print request are under the management of different users (referred to as Case 2). For example, as shown in FIG. 2, a mode in which the printer 200 of the user A is caused to print print data from the App server 400 under the management of the user B via the server 100 corresponds to Case 2. In this case, flat-rate charging is performed for one printer 200 of the user A. Therefore, with respect to the user A, a flat-rate fee for one printer 200 is charged to the user A. If the user A registers, that is, authorizes two printers to be used in the cloud printing service, a flat-rate fee for the two printers is charged to the user A. In Case 2, the user of the printer is a general user who uses a cloud printing service in order to use a specific content distribution service provided by another person, and in this case, it is statistically known that the amount of printing is less than the reference in many cases. Therefore, in Case 2, flat-rate charging for each printer is adopted.

In order to charge each user according to such a difference in the usage modes, in Case 1, the processor 110 of the server 100 performs the above preparation processing for usage-based charging at the time of partner registration for the user of the WebAPI. That is, when a print request is made using a WebAPI to a printer owned by a user registered as a partner, a description indicating that the usage-based charging is applied, acquisition of payment information of the user registered as a partner, and the like are performed as preparation processing. The processor 110 causes the user registered as a partner to select the user's own printer that performs a print request using the WebAPI. For example, in the case of the example of FIG. 2, the user B selects the printers 600 and 601.

In Case 2, the processor 110 performs the preparation processing for flat-rate charging when the user selects the user's own printer to be used in the cloud printing service. That is, as the preparation processing, an explanation that a flat rate is charged for one printer selected by the user, acquisition of payment information of the user, and the like are performed.

When the user authorizes the printer to be used in the cloud printing service, the processor 110 acquires the access token corresponding to the printer by the function of the authorization section 112. In the present embodiment, the processor 110 specifies the printer associated with the authenticated user with reference to the printer information 121 (see FIG. 2). The processor 110 displays a list of the specified printers on the terminal operated by the user and acquires the access token corresponding to the printer selected by the user from the list. That is, the processor 110 lists the identification information of the printers owned by the user, that is, the printers stored in association with the email address as the identification information of the user, and causes the terminal 300 to display a printer selection screen for selecting one of the listed identification information. When the user selects one printer to be used in the cloud printing service from the printers displayed in the list, the processor 110 acquires the identification information of the selected printer from the terminal 300. When the identification information of the printer selected by the user is acquired, the processor 110 considers that the user has authorized the use of the printer in the cloud printing service.

With the function of the authorization section 112, the processor 110 passes the access token to the App server. The access token is information generated so that the server 100 can uniquely identify the printer, for example, information obtained by combining random alphanumeric characters, but the access token is information generated separately from the identification information of the printer. The access token is information given to the App server having the authority to cause the user's printer to execute printing. When acquiring the access token, the App server stores the access token in the storage medium, and when making a print request to a printer corresponding to the access token, the App server designates the access token in the WebAPI of the print request and makes the print request. That is, the App server 400 transmits the print request and the access token to the server 100.

With the function of the printing control section 114, when the preparation processing for charging is performed, the processor 110 causes the printer to execute printing in response to the reception of the print request for the printer associated with the user. For example, as an example of Case 1, as shown in FIG. 2, when the App server 400 makes a print request to the printer B1, the App server 400 makes the print request to the server 100 by designating the print data, the access token of the printer B1, and the print setting in the WebAPI. The processor 110 of the server 100 collates the data designated as the access token in the WebAPI of the print request with the access token stored in the storage medium 120, and specifies the printer corresponding to the matched access token. The processor 110 converts the print data into a format suitable for printing the print data by the specified printer, transmits the print data to the printer, and requests printing. The printer that has received the request executes printing based on the print data.

In the present embodiment, when the printer corresponding to the access token designated by the App server in the print request is a printer corresponding to a user registered as a partner, the processor 110 records the amount of printing requested via the server 100 in the printer for a predetermined period. Here, the amount of printing indicates the number of printed sheets in the present embodiment. When the predetermined period ends, the processor 110 acquires the total number of printed sheets within the predetermined period. When there are a plurality of printers authorized by the user registered as a partner, the processor 110 adds the total number of printed sheets in a predetermined period in each printer, and calculates the total number of printed sheets in the predetermined period. The processor 110 calculates the amount of usage-based charging in a predetermined period by multiplying the fee per sheet by the total number of printed sheets. The processor 110 notifies the charging platform of the calculated amount and requests the charging processing for the user.

When the printer corresponding to the access token designated by the App server in the print request is a printer corresponding to a user who is not registered as a partner, the processor 110 notifies the charging platform of the amount of flat-rate charging for the printer in a predetermined period in response to the end of the predetermined period, and requests charging processing for the user.

As described above, according to the present embodiment, it is possible to charge a usage fee of the cloud printing service that causes printing by the printer via the server 100 in a mode corresponding to the amount of printing of the user's printer.

When the amount of printing is assumed to be less than the reference and the preparation processing for acquiring a printed matter based on print data transmitted from an apparatus associated with a first other user from the authorized printing apparatus is completed, the processor 110 does not newly perform the preparation processing for acquiring a printed matter based on print data transmitted from an apparatus associated with a second other user from the authorized printing apparatus.

For example, a printer A3 shown in FIG. 2 is a printer that performs printing in response to a print request from the App server 400, and is also a printer that performs printing in response to a print request from the App server 700. For example, when the user A has previously registered the printer A3 in order to use the content distribution service of the App server 400, the charging preparation processing is performed for the printer A3. Thereafter, when the user A has registered the printer A3 in order to use the content distribution service of the App server 700, the processor 110 does not newly perform preparation processing because the preparation processing has already been performed for the printer A3. Therefore, the processor 110 does not charge the user A for the flat-rate fee for the printer A3 redundantly after the predetermined period ends. Whether or not the charging preparation processing has been executed can be determined, for example, based on whether or not there is a history that an access token for the target printer has already been generated and issued (see the printer A3 in FIG. 2), whether or not the charging platform holds authenticated payment information for the target printer, or the like. In this way, it is possible to prevent the flat-rate charging for being redundantly performed for the same printer.

### 2. Authorization Sequence:

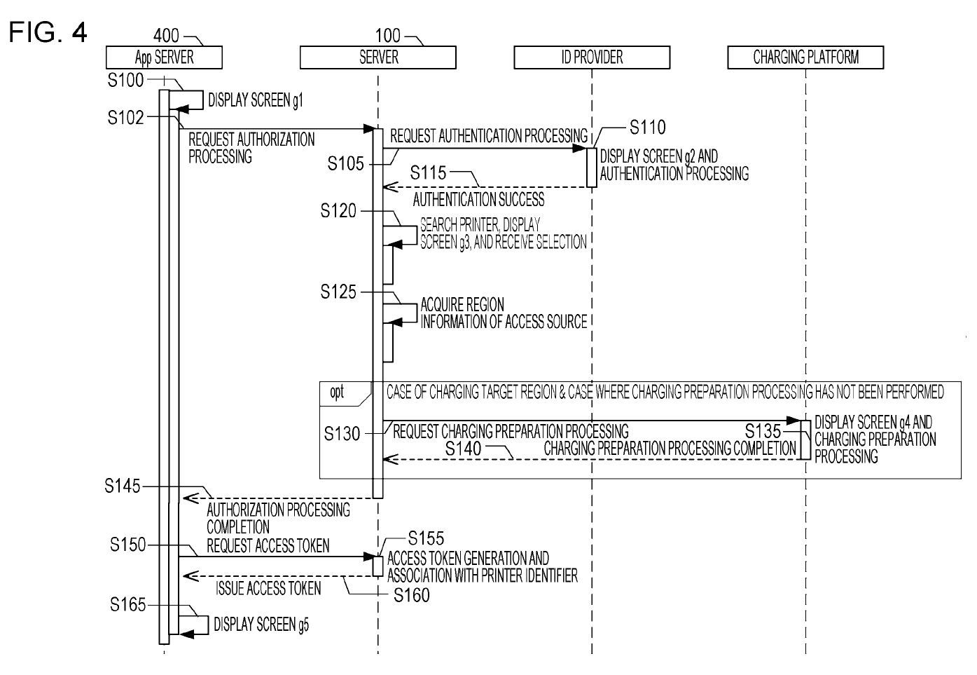

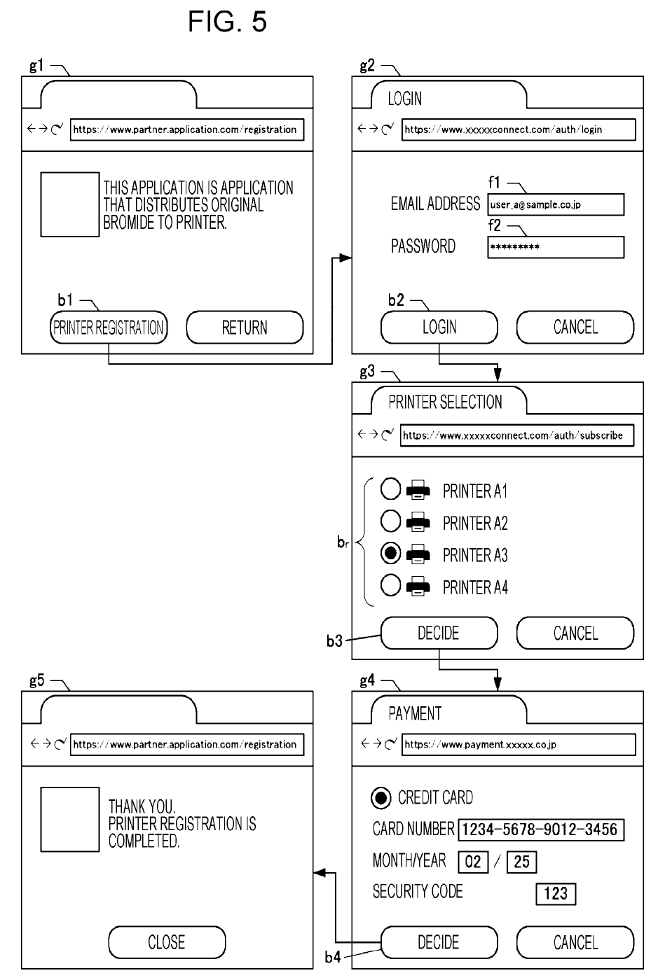

FIG. 4 is a sequence diagram showing an example of a schematic sequence of authorization of a printer and charging preparation in Case 2. FIG. 5 is a diagram showing an example of schematic screen transition in the terminal 300 of the user A in the sequence shown in FIG. 4.

A screen g1 is an example of a screen for prompting printer registration in a cloud printing service provided by the server 100 in a content distribution service provided by an App server (for example, 400). The screen g1 is displayed on the terminal 300 based on display data generated by the App server 400.

The App server 400 displays the screen g1 for prompting printer registration for cooperation with the cloud printing service (Step S100). When a printer registration button b1 is pressed on the screen g1, the terminal 300 transmits information indicating that the printer registration button b1 has been pressed to the App server 400. When receiving the information, the App server 400 transmits an authorization processing request to the server 100 (Step S102). When the processor 110 of the server 100 acquires the authorization processing request from the App server 400, the processor 110 uses the function of the authentication section 111 to request the ID provider to perform authentication processing (Step S105). When the authentication processing request is acquired, the ID provider displays a login screen as shown in a screen g2 on the terminal 300 and performs authentication processing (Step S110). That is, the ID provider transmits display data for displaying the screen g2 to the terminal 300. The terminal 300 displays the screen g2 when receiving the display data.

The screen g2 includes an email address input section f1, a password input section f2, and a login button b2. When the user inputs the email address and the password registered at the time of user registration of the cloud printing service to the email address input section f1 and the password input section f2, respectively, and presses the login button b2, the terminal 300 transmits the input email address and password to the ID provider. The ID provider collates the email address and the password transmitted from the terminal 300 with a combination of the email address and the password stored in the storage medium to perform user authentication. When the authentication is successful, the ID provider notifies the server 100 of the authentication success (Step S115).

When the notification of the authentication success is acquired, the processor 110 searches for a printer owned by the user using the function of the authorization section 112, displays a screen g3, and receives the selection of the printer (Step S120). That is, the processor 110 specifies the printer associated with the user successfully authenticated in Step S115 with reference to the printer information 121 (see FIG. 2). The processor 110 transmits display data for displaying the printer selection screen g3 including information indicating the specified printer to the terminal 300.

The screen g3 includes a list of printers associated with the authenticated users, radio buttons br corresponding to the respective printers, and a decision button b3. When the user selects one of the printers in the printer list by operating the radio button br and presses the decision button b3, the terminal 300 transmits information indicating the selected printer to the server 100. The screen g3 of FIG. 5 shows that a printer A3 is selected.

When the information indicating the selected printer is acquired, the processor 110 uses the function of the authorization section 112 to acquire region information indicating a region of an access source, that is, location information (Step S125). That is, the processor 110 acquires access source information, for example, an IP address or the like when the terminal 300 communicates with the server 100 as the location information of the user. When the access source is a charging target region, that is, when the access source corresponds to a predetermined region, and when the charging preparation processing has not been performed, the processor 110 transmits a charging preparation processing request to the charging platform (Step S130). Before Step S130, the processor 110 may cause the user's terminal 300 to display a description of contract contents such as the fee and the charging date, and may perform the processing of Step S130 when acquiring the user's approval from the terminal 300. Here, the region is a country. The region is not limited to a country, and may be a region including a plurality of countries or a region inside a country such as an administrative district.

When acquiring the charging preparation processing request, the charging platform performs the charging preparation processing (Step S135). That is, the charging platform transmits display data for displaying the screen g4 to the terminal 300. The screen g4 includes a selection button for a payment method, an input section for payment information, and a decision button b4. The example of the screen g4 shows a state in which a credit card is selected as a payment method, and a card number, an expiration date, and a security code are input. When the decision button b4 on the screen g4 is selected, the terminal 300 transmits these pieces of information to the charging platform. The charging platform authenticates the transmitted payment information of the user, stores the payment information in the storage medium, and notifies the server 100 of the completion of the charging preparation processing (Step S140).

When the region information of the access source in Step S125 does not indicate the charging target region, or when the charging preparation processing has been completed, the processing of Steps S130 to S140 are skipped. Therefore, after the end of Step S125, or after the end of Step S140, the processor 110 notifies the App server 400 of the completion of the authorization processing by the function of the authorization section 112 (Step S145).

When the notification of the completion of the authorization processing is acquired, the App server 400 transmits an access token request corresponding to the authorized printer to the server 100 (Step S150). When receiving the access token request, the processor 110 of the server 100 generates an access token of the authorized printer by the function of the authorization section 112, and stores the access token in the storage medium 120 in association with the identification information of the printer (Step S155). Then, the processor 110 transmits the generated access token to the App server 400 (Step S160). When acquiring the access token from the server 100, the App server 400 transmits the display data of the screen g5 to the terminal 300 and displays the screen g5 (Step S165).

As described above, the server 100 can issue, to the App server 400, an access token associated with an individual printer that the user has authorized for use with the cloud printing service. The App server 400 stores the issued access token in association with the user. In Step S160, a refresh token used for refreshing the access token may also be issued. In this case, the refresh token is also stored in the App server 400 in association with the user together with the access token.

When transmitting a print request to a printer owned by the user by using the WebAPI, the App server 400 designates an access token of the printer, print data to be printed, and a print setting. The processor 110 of the server 100 specifies the printer recorded in the storage medium 120 in association with the designated access token. When the printer associated with the designated access token has been specified, the processor 110, by the function of the printing control section 114, converts the print data to perform printing of the print data according to the print setting in the specified printer and transmits a print request of the converted print data to the printer 200.

The processor 210 of the printer 200 executes printing by controlling the printing section 250 based on the print data acquired from the server 100. When the printing is completed, the printer 200 transmits the printing completion notification to the server 100. When the printing completion notification is acquired from the printer 200, the server 100 transmits the printing completion notification to the App server 400.

In Case 1, for example, before the selection of the printer to be used in the cloud printing service (see Step S120 in FIG. 4 and the screen g3 in FIG. 5), the charging preparation processing for the usage-based charging is performed (see Steps S130 to S140 in FIG. 4 and the screen g4 in FIG. 5). After that, the printer to be used in the cloud printing service is selected (see Step S120 in FIG. 4 and screen g3 in FIG. 5), and then an access token is issued (see Steps S150 to S160 in FIG. 4).

When a printer corresponding to an access token designated by an App server in a print request is a printer corresponding to a user registered as a partner, the processor 110 totals the number of printed sheets requested via the server 100 for the printer during a predetermined period, calculates an amount of the usage-based charging according to the number of printed sheets after the end of the predetermined period, notifies the charging platform of the amount, and requests charging processing for the user.

When the printer corresponding to the access token designated by the App server in the print request is a printer corresponding to a user who is not registered as a partner, the processor 110 notifies the charging platform of the amount of flat-rate charging for each number of printers in a predetermined period in response to the end of the predetermined period, and requests charging processing for the user.

### 3. Other Embodiments:

The above embodiments are examples for carrying out the present disclosure, and various other embodiments can be adopted. For example, the server 100 may be configured by a plurality of server computers, and for example, each of the authentication section 111, the authorization section 112, the charging section 113, and the printing control section 114 may be realized by a separate server computer. The processing executed by the ID provider or the charging platform in the above embodiments may be executed by the server 100. For example, in the above embodiments, the server 100 generates the access token. However, another server may be requested to generate the access token, and the generated access token may be acquired.

As the amount of printing, for example, the number of printed sheets of cut paper, the printed length of roll paper, the size of print data, and the like may be assumed.

The charging section is configured to vary a charging mode for the user of the printing apparatus in accordance with an amount of printing by the printing apparatus. For example, the charging section may be configured to record the history of the amount of printing for each printer, to perform the flat-rate charging until the amount of printing exceeds a reference value, and to shift to the usage-based charging when the amount of printing exceeds the reference value.

A case where the amount of printing is assumed to be equal to or greater than the reference and a case where the amount of printing is assumed to be less than the reference are distinguished as follows, for example. The server 100 records, in advance, a history of the amount of printing in the cloud printing service for each printer, and specifies the most frequent usage mode as the usage mode of the printer whose amount of printing is equal to or greater than a reference, and the most frequent usage mode as the usage mode of the printer whose amount of printing is less than the reference value. In the above embodiments, the server 100 performs usage-based charging for the former and flat-rate charging for the latter.

As an example in which it is assumed that the amount of printing is equal to or greater than the reference, in addition to the above embodiments, for example, the user may select whether the assumed amount of printing is equal to or greater than the reference or less than the reference in advance at the time of printer authorization. When a value less than the reference is selected, printing in response to the print request after exceeding the reference may be prevented, or an inquiry may be made to the user regarding switching to usage-based charging after exceeding the reference, and when the user consents, switching to usage-based charging as described above may be performed.

The flat-rate charging when the amount of printing is assumed to be less than the reference may be configured such that a fixed amount is charged per printing apparatus for which printing is authorized in the printing service, and when a plurality of printing apparatuses are authorized, an amount obtained by multiplying the charge per printing apparatus by the number of printing apparatuses is charged. For example, the amount charged for the (N+1)th apparatus may be lower than the amount charged for the Nth apparatus.

When the printer of Case 1 is also the printer of Case 2, that is, when a print request is made from an App server of another partner to the printer of the user registered as a partner, for example, in the example of FIG. 2, when a print request is made from the App server 700 by designating the access token of the printer B1, and when the preparation processing of the usage-based charging already has been performed for the user B, the flat-rate charging for the printer B1 may not be performed. Alternatively, a configuration may be adopted in which charging in Case 1 and charging in Case 2 are performed separately.

The present disclosure can be applied to a printing system including the above information processing apparatus and printing apparatus. The present disclosure can also be applied to a program executed by a computer and a printing method. The printing method includes performing user authentication, performing preparation processing for charging a usage fee to an authenticated user for a printing service that causes a printing apparatus associated with the user to print print data via the information processing apparatus, causing the printing apparatus associated with the user to execute printing in response to receiving a print request for the printing apparatus when the preparation processing has been performed, and varying a charging mode for the user according to an amount of printing of the printing apparatus.

The system, the program, and the method described above may be realized as a single apparatus or may be realized by using components included in a plurality of apparatuses, and thus include various forms. In addition, the configuration can be appropriately changed in such a manner that a part of the configuration is software and a part of the configuration is hardware. In addition, the disclosure can also be realized as a recording medium for a program for controlling the system. Undoubtedly, the recording medium for the program may be a magnetic recording medium or a semiconductor memory, and any recording medium to be developed in the future can be considered in the same manner.

What is claimed is:

1. An information processing apparatus comprising:
an authentication section configured to perform user authentication;
a charging section configured to perform preparation processing for charging a usage fee to an authenticated user for a printing service that causes a printing apparatus associated with the user to print print data via the information processing apparatus; and
a printing control section configured to cause the printing apparatus associated with the user to execute printing in response to receiving a print request for the printing apparatus when the preparation processing has been performed, wherein
the charging section varies a charging mode for the user according to an amount of printing of the printing apparatus.

2. The information processing apparatus according to claim 1, wherein
the charging section
performs usage-based charging when the amount of printing is assumed to be equal to or greater than a reference, and
performs flat-rate charging when the amount of printing is assumed to be less than the reference.

3. The information processing apparatus according to claim 2, wherein
the charging section
performs the flat-rate charging in which a fixed amount is charged per printing apparatus authorized to perform printing in the printing service, when the amount of printing is assumed to be less than the reference.

4. The information processing apparatus according to claim 2, wherein
when the amount of printing is assumed to be equal to or greater than the reference, an apparatus associated with the user makes a print request for causing the printing apparatus authorized to perform printing in the printing service to print print data, and the user acquires a printed matter based on the print request from the printing apparatus, and
when the amount of printing is assumed to be less than the reference, an apparatus associated with another user different from the user makes a print request for causing the printing apparatus authorized to perform printing in the printing service to print print data, and the user acquires a printed matter based on the print request from the printing apparatus.

5. The information processing apparatus according to claim 4, wherein
when the amount of printing is assumed to be less than the reference and the preparation processing for acquiring a printed matter based on print data transmitted from an apparatus associated with a first other user from the authorized printing apparatus is completed, the charging section does not newly perform the preparation processing for acquiring a printed matter based on print data transmitted from an apparatus associated with a second other user from the authorized printing apparatus.

6. A printing system comprising:
an information processing apparatus and a printing apparatus, wherein
the information processing apparatus includes
an authentication section configured to perform user authentication,
a charging section configured to perform preparation processing for charging a usage fee to an authenticated user for a printing service that causes the printing apparatus associated with the user to print print data via the information processing apparatus, and
a printing control section configured to cause the printing apparatus associated with the user to execute printing in response to receiving a print request for the printing apparatus when the preparation processing has been performed, the charging section varies a charging mode for the user according to an amount of printing of the printing apparatus, and
the printing apparatus executes printing requested by the information processing apparatus.

7. A printing method comprising:
performing user authentication;
performing preparation processing for charging a usage fee to an authenticated user for a printing service that causes a printing apparatus associated with the user to print print data via the information processing apparatus;
causing the printing apparatus associated with the user to execute printing in response to receiving a print request for the printing apparatus when the preparation processing has been performed; and
varying a charging mode for the user according to an amount of printing of the printing apparatus.
